(19) United States
(12) Patent Application Publication
(10) Pub. No.: US 2004/0266014 A1
(43) Pub. Date: Dec. 30, 2004

(54) Removing contaminations due to polymer aggregation in photoresist

(76) Inventors: Hok-Kin Choi, San Jose, CA (US); Hai Deng, Mountain View, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/611,029

(22) Filed: Jun. 30, 2003

(51) Int. Cl. G01N 35/00

(52) U.S. Cl. 436/45

(57) ABSTRACT

An embodiment of the present invention includes a technique to remove a contaminant from a resist. A resist having a resist volume is spun in a centrifuige tube of a centrifuge at a pre-defined spinning rate corresponding to the resist volume in a time period to provide a gel. The gel is located under a lighting condition. The resist is decanted from the centrifuge tube.

### BACKGROUND

1. Field of the Invention

Embodiments of the invention relates to the field of semiconductor, and more specifically, to lithography.

2. Description of Related Art

Wafer defects may be caused by various types of contaminants including hard particles, ionic contaminants, bubbles, etc. Contaminants may be transferred from wafer carriers, storage boxes, shippers, and pods to the wafer during shipping and handling. In addition, fabrication processes and equipment introduce contaminants such as particulate, metallic, organic, or ionic.

Although a number of techniques have been used to control contamination caused by hard particles, bubbles and micro-bubbles, and ionic contaminants, there is currently no effective technique to detect, remove, or monitor soft gel. Existing techniques such as Point of Use (POU) filters are not effective in removing soft gel because it exists as a disperse viscous fluid and chemical structures are similar to the photoresist.

### BRIEF DESCRIPTION OF THE DRAWINGS

The invention may best be understood by referring to the following description and accompanying drawings that are used to illustrate embodiments of the invention. In the drawings:

FIG. 1 is a diagram illustrating a system in which one embodiment of the invention can be practiced.

FIG. 2 is a flowchart illustrating a process to remove contaminant according to one embodiment of the invention.

FIG. 3 is a diagram illustrating a Nuclear Magnetic Resonance (NMR) spectrum according to one embodiment of the invention.

FIG. 4 is a diagram illustrating a Gas Permeation Chromatography (GPC) according to one embodiment of the invention.

### DESCRIPTION

An embodiment of the present invention includes a technique to remove a contaminant from a resist. A resist having a resist volume is spun in a centrifuge tube of a centrifuge at a pre-defined spinning rate corresponding to the resist volume in a time period to provide a gel. The gel is located under a lighting condition. The resist is decanted from the centrifuge tube.

In the following description, numerous specific details are set forth. However, it is understood that embodiments of the invention may be practiced without these specific details. In other instances, well-known circuits, structures, and techniques have not been shown in order not to obscure the understanding of this description.

One embodiment of the invention may be described as a process which is usually depicted as a flowchart, a flow diagram, a structure diagram, a sequence of operations, a sequence of fabrication phases, or a block diagram. Although a sequence of operations may describe the operations as a sequential process, many of the operations can be performed in parallel or concurrently. In addition, the order of the operations may be re-arranged. A process is terminated when its operations are completed. A process may correspond to a method, a program, a procedure, etc.

An embodiment of the invention is a technique to remove a contaminant from a resist during the semiconductor fabrication process. The technique involves spinning the resist at a high spinning rate of approximately 13,000 rpm for at least two hours. The gel is spun out of the resist and can be analyzed to determine the chemical structure and molecular weight. The technique is used to (1) detect gel contamination in the resist, (2) remove the gel contamination without using time-consuming purification procedures for nubs defect reduction, and (3) monitor the shelf life of the resist using the gel information. The technique is simple and reliable. It can be used by photoresist manufacturer to monitor or inspect the stock/bulk solutions before shipping. The technique is more effective than the traditional filtering method which is inefficient to detect gel-like polymer which exists as a disperse viscous fluid in the photoresist solution.

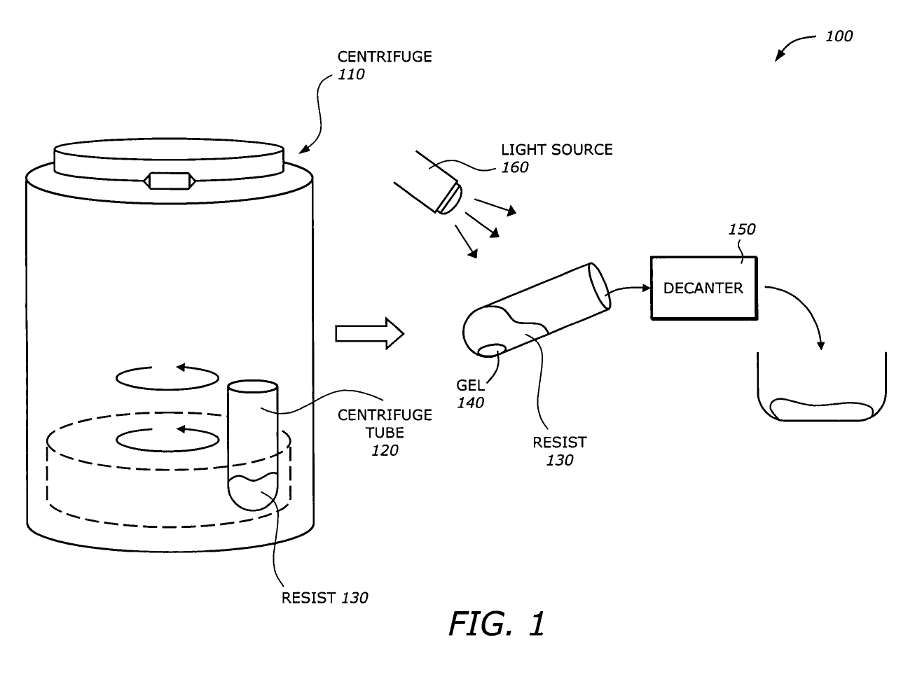

FIG. 1 is a diagram illustrating a system 100 in which one embodiment of the invention can be practiced. The system 100 includes a centrifuge 110, a decanter 150, and a light source 160.

The centrifuge 110 has a chamber which contains at least a centrifuge tube 120. The centrifuge 110 may have control settings to control spinning rate and temperature. In one embodiment, the spinning rate may range from 10,000 revolutions per minutes (rpm) to 20,000 rpm. The temperature may be set at approximately 18 degrees Celsius or lower.

The centrifuge tube 120 contains a resist 130. The resist 130 may be any resist including long-chain non-cross-linked resists such as Poly(methyl methacrylate) (PMMA) and chemically amplified resists (CAR). Examples of other resists may be copolymer, diazonaph thaquinone (DNQ)—Novolac, NEB-31 provided by Sumitomo Chemical America, Santa Clara, USA, poly(α—chloro acrylate-co-α-methyl styrene) such as the ZEP series provided by Nippon Zeon Company in Japan, poly (butene-1-sulfone) and poly (2,2,2-trifluoroethyl-α-chloro-acrylate) such as the EBR-9 provided by Toray, Inc., San Mateo, Calif., USA and UV-5 Photoresist provided by Shipley Company, Massachusetts, USA. The resist 130 may be any resist for 193 nm or 157 nm optical lithography including inorganic-organic hybrid type, i.e., resists made by materials that combine the desired characteristics of organic resists with those of inorganic constituents. The resist 130 may be contaminated by contaminants such as soft gel due to polymer aggregation. It is desired to remove the soft gel from the resist as much as possible to ensure purified resist for the semiconductor fabrication process.

The centrifuge 110 spins the resist 130 in the centrifuge tube 120 at a pre-defined spinning rate in a time period. The resist 130 has a resist volume. In one embodiment, the spinning rate is related to the resist volume. For example, when the resist volume is about 6.4 milliliter (ml), the spinning rate is approximately 13,000 rpm. It is anticipated that the larger the volume, the faster the spinning rate. The time period may also be a factor related to the resist volume. In one embodiment, the time period is about two hours or more.

After the centrifuge 120 stops spinning, the centrifuge tube 120 is removed from the centrifuge 110. If there is any gel contamination, such as a gel 130, it is formed at the bottom or on the wall of the centrifuge tube 120. The micro gel 130 is soluble in Deuterated Chloroform (CDC13) and Tetrahydrofuran (THF). In general, the gel 130 is colorless and needs to be examined or located under a light condition such as under the white light source 160. The purified resist 130 is then decanted or poured off by the decanter 150 from the centrifuge tube 120 and the gel 140 may be discarded or analyzed.

The gel 130 can be analyzed or studied to determine the chemical structure using nuclear magnetic resonance (NMR) and the molecular weight using Gel Permeation Chromatography (GPC). From this determination, the shelf life of the resist can be monitored before resist processing.

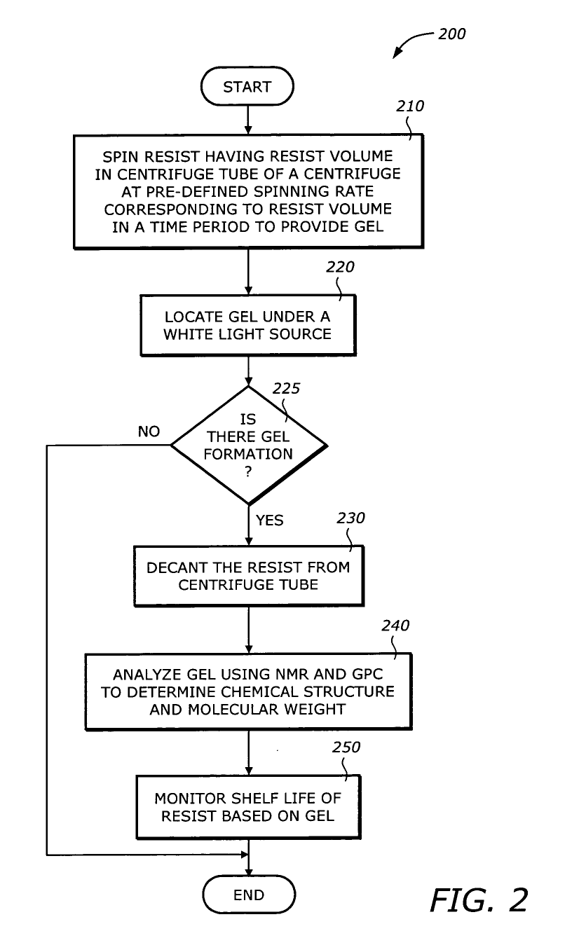

FIG. 2 is a flowchart illustrating a process 200 to remove contaminant according to one embodiment of the invention.

Upon START, the process 200 spins the resist having a resist volume in a centrifuge tube of a centrifuge at a pre-defined spinning rate corresponding to the resist volume in a time period to provide a gel (Block 210). The resist may be any type of resist that may be contaminated by formation of gel. Next, the process 200 locates the gel under a lighting condition such as one provided by a white light source (Block 220). The process 200 determines if there is a gel formation (Block 225). If not, there is no contamination and the batch containing the resist sample is considered good batch and the process is terminated. Otherwise, the resist is contaminated and the batch is considered bad. Usually, the gel is formed at the bottom or on the wall of the centrifuge tube.

Then, the process 200 decants the resist from the centrifuge tube (Block 230) and removes the gel. Next, the process 200 analyzes the gel using Nuclear Magnetic Resonance (NMR) or Gel Permeation Chromatography (GPC) to determine the chemical structure and the molecular weight of the gel. The NMR is used to determine or estimate the chemical structure. The GPC is used to determine or estimate the molecular weight. This determination may be useful to positively identify the gel contaminant and to provide quantitative information for the analysis.

Next, the process 200 monitors the shelf life of the resist based on the gel information (Block 250) and is then terminated. Monitoring the shelf life may be performed by estimating the shelf life based on a determination of the resist materials, gel characteristics such as size, molecular weight, volume, etc., and other parameters such as equipment set up, centrifuge spinning rate, etc.

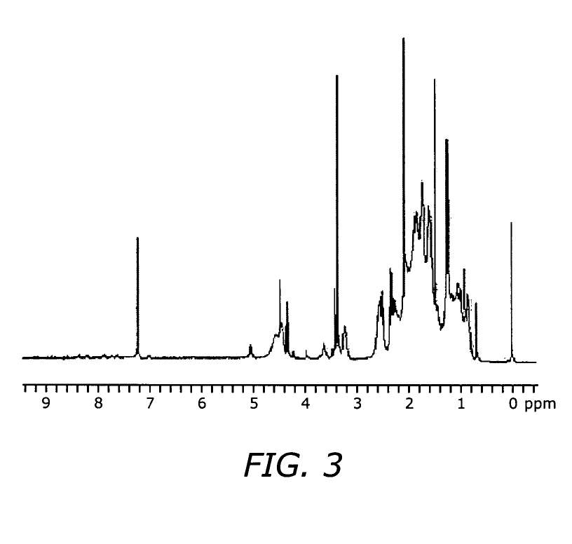

FIG. 3 is a diagram illustrating a Nuclear Magnetic Resonance (NMR) spectrum according to one embodiment of the invention.

An experiment is performed to show the removal of a micro gel in a resist. The resist is a AR230 type provided by JSR Microelectronics located at 1280 North Mathilda Avenue, Sunnyvale, Calif. 94089. The resist is spun at 13,000 rpm and has a resist volume of 6.4 ml. The spinning of the resist provide a colorless micro gel of about 2 mg, or approximately 0.15% of the resist polymer weight. The NMR spectrum indicates that the micro gel contamination is a lactone rich acrylic type copolymer. The chemical structure of the gel is therefore similar to the resist polymer.

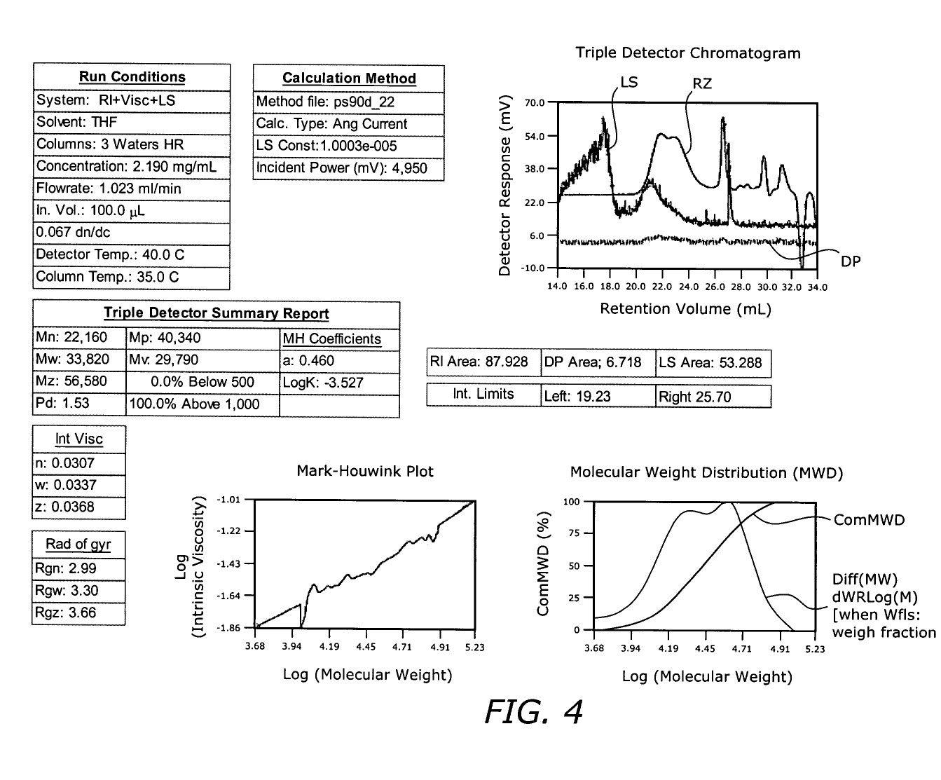

FIG. 4 is a diagram illustrating a Gas Permeation Chromatography (GPC) according to one embodiment of the invention.

The GPC is performed with a triple detector system (concentration, infrared (IR); viscosity, degrees of polymerization (DP); and light scattering, LS). The result indicates that the molecular weight of the micro gel is about 33,000 while the molecular weight of the resist is about 10,000.

The experiment shows that the gel contaminant has a chemical structure similar to the photoresist with the molecular weight of about three times the photoresist polymer.

While the invention has been described in terms of several embodiments, those of ordinary skill in the art will recognize that the invention is not limited to the embodiments described, but can be practiced with modification and alteration within the spirit and scope of the appended claims. The description is thus to be regarded as illustrative instead of limiting.

What is claimed is:

1. A method comprising:
spinning a resist having a resist volume in a centrifuge tube of a centrifuge at a pre-defined spinning rate corresponding to the resist volume in a time period to provide a gel;
locating the gel under a lighting condition; and
decanting the resist from the centrifuge tube.

2. The method of claim 1 wherein spinning comprises:
spinning the resist at the spinning rate of at least 13,000 revolutions per minutes (rpm).

3. The method of claim 1 wherein spinning comprises:
spinning the resist for the time period of two hours or longer.

4. The method of claim 1 wherein spinning comprises:
spinning the resist under a temperature of 18 degrees Celsius or lower.

5. The method of claim 1 wherein locating the gel comprises:
locating the gel under a white light source.

6. The method of claim 1 further comprising:
analyzing the gel to determine one of chemical structure and molecular weight.

7. The method of claim 1 further comprising:
analyzing the gel using one of a nuclear magnetic resonance (NMR) and gel permeation chromatography (GPC).

8. The method of claim 1 further comprising:
monitoring shelf life of the resist based on the gel.

9. The method of claim 1 wherein spinning the resist comprises:
spinning the resist being one of a long chain non-cross-linked resist and a chemically amplified resist.

10. The method of claim 9 wherein spinning the resist comprises:
spinning the resist being an acrylic polymer.

11. An apparatus comprising:
a centrifuge having a centrifuge tube to spin a resist having a resist volume at a pre-defined spinning rate corresponding to the resist volume in a time period to provide a gel, the gel being located under a lighting condition, the resist being decanted from the centrifuge tube.

12. The apparatus of claim 11 wherein the centrifuge spins the resist at the spinning rate of at least 13,000 revolutions per minutes (rpm).

13. The apparatus of claim 11 wherein the centrifuge spins the resist for the time period of two hours or longer.

14. The apparatus of claim 11 wherein the centrifuge spins the resist under a temperature of 18 degrees Celsius or lower.

15. The apparatus of claim 11 wherein the gel is located under a white light source.

16. The apparatus of claim 11 further comprising:
an analyzer to analyze the gel to determine one of chemical structure and molecular weight.

17. The apparatus of claim 11 further comprising:
an analyzer to analyze the gel using one of a nuclear magnetic resonance (NMR) and gel permeation chromatography (GPC).

18. The apparatus of claim 11 wherein the gel is used to monitor shelf life of the resist based on the gel.

19. The apparatus of claim 11 wherein the resist is one of a long chain non-cross-linked resist and a chemically amplified resist.

20. The apparatus of claim 19 wherein the resist is an acrylic polymer.

21. A system comprising:
a white light source;
a decanter; and
a centrifuge to detect contaminant in a resist, the centrifuge having a centrifuge tube to spin a resist having a resist volume at a pre-defined spinning rate corresponding to the resist volume in a time period to provide a gel, the gel being located under a lighting condition, the resist being decanted by the decanter from the centrifuge tube.

22. The system of claim 21 wherein the centrifuge spins the resist at the spinning rate of at least 13,000 revolutions per minutes (rpm).

23. The system of claim 21 wherein the centrifuge spins the resist for the time period of two hours or longer.

24. The system of claim 21 wherein the centrifuge spins the resist under a temperature of 18 degrees Celsius or lower.

25. The system of claim 21 wherein the gel is located under the white light source.

26. The system of claim 21 further comprising:
an analyzer to analyze the gel to determine one of chemical structure and molecular weight.

27. The system of claim 21 further comprising:
an analyzer to analyze the gel using one of a nuclear magnetic resonance (NMR) and gel permeation chromatography (GPC).

28. The system of claim 21 wherein the gel is used to monitor shelf life of the resist based on the gel.

29. The system of claim 21 wherein the resist is one of a long chain non-cross-linked resist and a chemically amplified resist.

30. The system of claim 29 wherein the resist is an acrylic polymer.
